(19) United States
(12) Patent Application Publication
(10) Pub. No.: US 2018/0293111 A1
(43) Pub. Date: Oct. 11, 2018

(54) CDN-BASED CONTENT MANAGEMENT SYSTEM

(71) Applicant: WANGSU SCIENCE & TECHNOLOGY CO.,LTD., Shanghai (CN)

(72) Inventors: Liang CHEN, Shanghai (CN); Gengxin LIN, Shanghai (CN)

(21) Appl. No.: 15/570,961

(22) PCT Filed: Jul. 17, 2015
(86) PCT No.: PCT/CN2015/084341

§ 371 Date: Oct. 31, 2017

(30) Foreign Application Priority Data
May 12, 2015 (CN) 201510239665.2

(51) Int. Cl. G06F 9/50; G06F 9/48; G06F 11/20; H04L 29/08

(52) U.S. Cl. CPC G06F 9/5083; G06F 9/4881; G06F 11/2025; G06F 2201/85; H04L 67/2842; H04L 67/10; G06F 9/505

(57) ABSTRACT

The present disclosure provides a CDN-based content management system, including: a distributed scheduling center, a big data center, a task executing server cluster, a distributed reliability coordinating system, and content caching servers; the distributed scheduling center includes a plurality of distributed scheduling servers, and is configured to schedule tasks based on client requests; the big data center is configured to store client task request data, and count and analyze task data; the task executing server cluster is deployed in different regions and different operators, configured to receive task conversion commands sent by the distributed scheduling servers, and send task commands to content caching servers of corresponding regions and operators; and the distributed reliability coordinating system is configured to store status and properties of all servers in the content management system; and the content caching servers are configured to cache client files.

### FIELD OF THE DISCLOSURE

The present disclosure generally relates to the field of content management system and, more particularly, relates to a content delivery network (CDN)-based content management system.

### BACKGROUND

With the rapid development of the Internet, more and more users rely on the Internet to browse webpages, listen to music, and watch videos. To ensure users can quickly obtain network information, more and more internet websites require CDN for acceleration. The basic idea of CDN is to avoid bottlenecks and links, on the internet, that can possibly affect the speed and stability of data transmission, so that content can be transmitted with higher speed and higher stability. Specifically, CDN caches customer data in edge nodes to increase the access speed of client terminals.

In conventional technology, edge cache servers cache files in the following two sections:

First, a client sending a push request, to solve the problems associated with updates in the source files of the client, deleting files or performing expiration processing on the files.

Second, by predictively analyzing possible hotspots, performing a prefetch operation, to improve user's experience of the first access.

However, the abovementioned methods cause edge servers to cache a large number of cached files, and have the following shortcomings:

(1) conventional CDN products lack content management on edge servers, and are not able to manage the entire life cycle of the cached files;

(2) conventional CDN products are not able to perform targeted processing on cached files of different caching types, e.g., performing live streaming control, streaming media format conversion, and image format conversion for streaming media content; and

(3) conventional CDN products are not able to implement precise range control, precise traffic control, and hot and cold prefetches in the prefetch function of the cached files.

### BRIEF SUMMARY OF THE DISCLOSURE

In view of the shortcomings in above-mentioned conventional technology, the goal of the present disclosure includes providing a CDN-based content management system. The target URL and the operation types may be sent to distributed scheduling servers (Master), and the Master servers may send the target URL and the operation types to the task execution servers (Work) based on scheduling policies. The Work servers may distribute task messages to all content caching servers (CacheServer) at a shortest time, and the CacheServer servers may receive content management commands and manage cached files.

To realize the abovementioned goal and other related goals, the present disclosure provides a CDN-based content management system, including: a distributed scheduling center, a big data center, a task executing server cluster, a distributed reliability coordinating system, and content caching servers; the distributed scheduling center includes a plurality of distributed scheduling servers, and is configured to schedule tasks based on client requests; the big data center is configured to store client task request data, and count and analyze task data; the task executing server cluster is deployed in different regions and different operators, configured to receive task conversion commands sent by the distributed scheduling servers, and send task commands to content caching servers of corresponding regions and operators; the distributed reliability coordinating system is configured to store status and properties of all servers in the content management system; and the content caching servers are configured to cache client files, and the content caching servers are arranged with a content management client terminal; and the content management client terminal executes tasks allocated by a task executing server and send task results as feedback to the task executing server.

Based on the CDN-based content management system, in the distributed scheduling center, one distributed scheduling server is selected as a central scheduling server, when any one of the distributed scheduling servers fails, the central scheduling server selects another distributed scheduling server to take over work load of failed distributed scheduling server, and when the central scheduling server fails, other distributed scheduling servers select a new central scheduling server to take over work load from previous central scheduling server.

Based on the CDN-based content management system, a distributed scheduling server includes a system interface module, a task scheduling module, a policy module, a task executing load balancing module, and a sub-task allocating module; the system interface module is configured to receive and verify client content management requests, store task data, and simultaneously add tasks into a task queue; the policy module is configured to generate different policies for clients based on service configuration data and client types; the task scheduling module is configured to obtain tasks from the task queue based on the policy and configuration of current clients, initiate the tasks and schedule tasks for execution; the task executing load balancing module is configured to register current load, CPU, memory, and task allocation of the task executing servers, and based on principles of prioritizing same region and the operators, select a task executing server having a lowest synthetic load to execute allocated tasks; and the sub-task allocating module is configured to split the task data into sub-tasks based on regions and operators, send the sub-tasks to corresponding target task executing server, and maintain a connection relationship between the task executing server and the sub-tasks.

Further, based on the CDN-based content management system, the sub-task allocating module splits the task data by picking one out of two based on regions and operators, uses j son as a language for data exchange to program the task data, and uses asynchronous communication mechanism to send the task data.

Based on the CDN-based content management system, the task executing server includes a sub-task receiving module, a task computing module, a message sending module, a task feedback module, and a caching module; the sub-task receiving module is configured to receive sub-tasks sent by the distributed scheduling servers, and add the sub-tasks into a task queue; the task computing module is configured to calculate ranges of the content caching servers covered by the tasks based on client CDN acceleration information cached in the caching module, and generate task commands; the message sending module is configured to send the task commands to all target computers; the task feedback module is configured to receive task results fed back from the content management client terminals, and update task progress based on the task results; and the caching module is configured to cache a status of each node in the CDN, and update software and hardware failures of all nodes in real-time; and store and update the client service configuration data in real-time, and cache calculation results of target tasks.

Further, based on the CDN-based content management system, when the message sending module is sending the task commands to the target computers, if the task commands are unsuccessfully sent, caused by a feedback from client terminal showing failure or a failure caused by a timeout, the message sending module attempts to resend the task commands for a plurality of times, and adds the task commands into the task queue when attempting to resend.

Based on the CDN-based content management system, the content management client terminal includes a policy processing module, a task executing module, and a task feedback module; the protocol processing module is configured to receive and analyze task commands sent by the task executing servers, and add the task commands into a task queue; the task executing module is configured to obtain tasks from the task queue, and execute the tasks; and the task feedback module is configured to send task results as feedbacks to the task executing servers.

Based on the CDN-based content management system, when executing a task, the task executing module first determines task types; if the task is a prefetch task, the task executing module starts downloading files, and reports a download progress to the task executing servers on a regular basis; if the task is a push task, the task executing module labels files as expired or deletes the files; if the task is a file verification task, the task executing module calculates MD5 values of corresponding files; and if the task is a file conversion task, the task executing module performs a format conversion based on target files.

Further, based on the CDN-based content management system, an execution of a prefetch task includes following steps: a client submitting a prefetch task request; a client task request being directed to any of the distributed scheduling servers through a load balancing server; the distributed scheduling server verifying task data, and directing tasks to a currently prioritized task executing server based on corresponding prefetch policies, and load property information of the task executing server; the task executing server calculating acceleration ranges of the client in the CDN, locating the load balancing server deployed with an accelerating node caching server, and inquiring a corresponding content caching server; the load balancing server returns an ip of the corresponding content caching server; and the task executing server sending a prefetch command to the content management client terminal of the content caching server; determining if a file for the prefetch exists; if the file does not exist, the task executing server requesting for the file from a first-tiered content caching server; and the first-tiered content caching server determining an existence of the file; if the file does not exist, the first-tiered content caching server requesting for the file from a client source server.

Further, based on the CDN-based content management system, an execution process of the push task includes following steps: a client submitting a push task request; the client request being directed to any of the distributed scheduling servers through a load balancing server; the distributed server verifying task data, splitting task into a plurality of sub-tasks based on information of regions or operators, and allocating the sub-tasks onto a plurality of task executing servers; the task executing servers calculating acceleration ranges of the client in the CDN based on information of regions or operators; the task executing servers sending push commands to the content management client terminal of a first-tiered content caching server, and the content management client terminal pushing cached files; and when completing all the push tasks on the first-tiered content caching server, sending push commands to a second-tiered content caching server to push files.

As mentioned above, the disclosed CDN-based content management system may have the following advantages:

(1) distributed Master-Work architecture may be applied, and an arbitrary number of Master servers and Work servers may be deployed. A plurality of Master servers may form a distributed scheduling center, and one Master server may be selected as the central scheduling server (NameMaster, or NM), to be in charge of global service management. By applying lateral extension distribution of the Master servers, the throughput of the system may be increased;

(2) content management system supports: prefetch, push, file verification (coverage), image format conversion, video conversion, live broadcast control, and other content management requests, in addition, by increasing Work servers and extending terminals Beacon on caching server clients, caching management functions may be rapidly added;

(3) a distributed reliability coordinating system may be applied to manage cluster status, and the status of all computers in a cluster may be monitored. When failure occurs, Bully algorithm may be applied in the Master cluster to select the Master server with the highest number to take over global coordination. In the Work cluster, by combining a switch between the master and the replacement with an intelligent scheduling by the Master, the system may have a high availability;

(4) the Master servers may receive clients' requests, split tasks with operators based on load balancing and scheduling policies and sent split tasks to different Work servers, so as to take advantage of the regions and operators that the work Servers are located in to allocate tasks with reliability and high efficiency. Reliability problems caused by inter-operator network may be solved.

(5) task data may be stored in the big data center to solve the growing demand for content management. Also, through the big data center, real-time operations of the clients may be statistically analyzed, and the content management demands of the clients' may be studied and analyzed.

### BRIEF DESCRIPTION OF THE DRAWINGS

FIG. 1 illustrates a structure of an exemplary CDN-based content management system according to the disclosed embodiments of the present disclosure;

FIG. 2 illustrates a structure of an exemplary Master server according to the disclosed embodiments of the present disclosure;

FIG. 3 illustrates an exemplary process flow of a Master server according to the disclosed embodiments of the present disclosure;

FIG. 4 illustrates a structure of an exemplary Work server according to the disclosed embodiments of the present disclosure;

FIG. 5 illustrates an exemplary process flow of a Work server according to the disclosed embodiments of the present disclosure;

FIG. 6 illustrates an exemplary process flow of a message sending module according to the disclosed embodiments of the present disclosure;

FIG. 7 illustrates a structure of an exemplary content management client terminal Beacon according to the disclosed embodiments of the present disclosure;

FIG. 8 illustrates a process flow of an exemplary prefetch operation according to the disclosed embodiments of the present disclosure; and

FIG. 9 illustrates a process flow of an exemplary push operation according to the disclosed embodiments of the present disclosure.

### DESCRIPTION OF LABELING OF ELEMENTS

| | |
|---|---|
| 1 | distributed scheduling center |
| 2 | big data center |
| 3 | task executing server cluster |
| 4 | distributed reliability coordinating system |
| 5 | content caching server |
| 11 | system interface module |
| 12 | task scheduling module |
| 13 | policy module |
| 14 | Work load balancing module |
| 15 | sub-task allocating module |
| 31 | sub-task receiving module |
| 32 | task computing module |
| 33 | message sending module |
| 34 | task feedback module |
| 35 | caching module |
| 51 | protocol processing module |
| 52 | task executing module |
| 53 | task feedback module |

### DETAILED DESCRIPTION

Specific embodiments are illustrated as follows to describe the present disclosure. Those skilled in the art can easily understand the other advantages and effects of the present disclosure. The present disclosure may also be implemented or applied using other different embodiments. The various details in the present disclosure may also be based on different perspectives and applications, and may have various modifications and changes without departing from the spirit of the present disclosure.

It should be noted that, the figures provided by the disclosed embodiments are only exemplary to illustrate the basic idea of the present disclosure. Thus, the figures only show components related to the disclosure and the components are not depicted in accordance with the actual number of components, and the shape and size of the components in implementations. The actual form, quantity, and ratio of a component can vary arbitrarily in implementations, and the layout patterns of the components can be more complex.

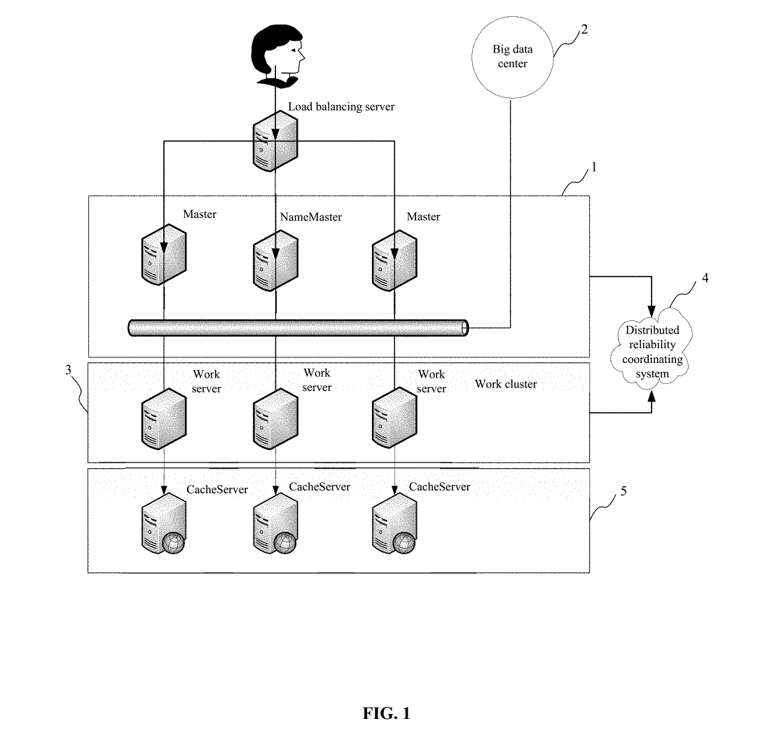

As shown in FIG. 1, the CDN-based content management system provided by the present disclosure may include a distributed scheduling center 1, a big data center 2, a task executing server cluster (Work cluster) 3, a distributed reliability coordinating system 4, and content caching servers (CacheServer) 5.

The distributed scheduling center 1 may include a plurality of distributed scheduling servers (Master servers), configured to schedule tasks based on clients' requests. The main functions of the Master servers may include in charge of receiving and analyzing tasks and storing data, managing clusters, and scheduling tasks and managing life cycles of tasks. Specifically, through lateral extension distribution of a plurality of distributed scheduling servers, the throughput of the system may be increased and high availability may be ensured. Meanwhile, the front end may apply a reverse proxy for load balancing, so that the clients' requests can be uniformly distributed on a plurality of distributed scheduling servers.

In the distributed scheduling center 1, one Master server may be selected as the central scheduling server (NameMaster). NameMaster may monitor the information of all Master servers in the cluster. If NameMaster detects any of the Master servers fails, the NameMaster may select another Master server to take over the work load of the failed Master server, based on load condition; if NameMaster fails, other Master servers may select a NameMaster using bully algorithm, when the selection is complete, a new NameMaster may take over the work load from the previous NameMaster.

The big data center 2 may be configured to store a massive number of clients' task request data, and may count and analyze task data.

The Work cluster 3 may be deployed in different regions and different operators, configured to receive the task conversion commands sent by the distributed scheduling servers, and, through computation, send task commands to the content caching servers of corresponding regions and operators.

The distributed reliability coordinating system 4 may be configured to store the status and properties of all the servers in the content management system.

A content caching server 5 may be arranged with a content management client terminal Beacon, for caching clients' files.

Specifically, a content management client terminal Beacon may be configured to execute tasks assigned by Work servers, and send results of the tasks as feedback to the Work servers. In an ordinary CDN network, a multi-tiered cache architecture may be included. In one embodiment, a two-tiered cache architecture may be used as an example. The two-tiered cache architecture may be referred to as a first-tier cache and a second-tier cache, but the disclosure should not be limited to the two-tiered cache architecture. Content caching servers may include a multi-tiered cache architecture according to application requirements.

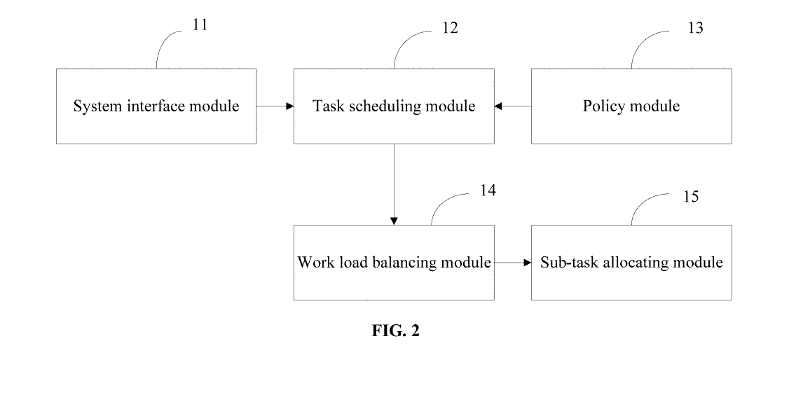

As shown in FIG. 2, A Master server may include a system interface module 11, a task scheduling module 12, a policy module 13, a task executing (Work) load balancing module 14, and a sub-task allocating module 15. The task scheduling module 12 may be connected to the system interface module 11, the policy module 13, and the Work load balancing module 14, respectively. The Work load balancing module 14 may further be connected to the sub-task allocating module 15.

The system interface module 11 may be configured to receive and verify clients' content management requests, and store task data. Meanwhile, the system interface module 11 may add tasks into the task queue.

The task scheduling module 12 may be configured to obtain tasks from the task queue based on the policy and the configuration of the current clients. The task scheduling module 12 may initiate the tasks and scheduling tasks for execution.

The policy module 13 may generate different policies for clients based on service configuration data and client types, for the task scheduling module to use.

Specifically, the service configuration data may include but is not limited to acceleration ranges of clients' regions, rankings of clients, etc.; the client types may include but are not limited to webpages, images, downloads, on-demands, and live broadcast.

The Work load balancing module 14 may be configured to register the current load, CPU, memory, and task allocation of the Work servers, and based on the principles of prioritizing the same region and the operators, select the Work server having the lowest synthetic load to execute the allocated task.

Specifically, Master servers may register the current load, CPU, memory, and task allocation of the Work servers through ZooKeeper. ZooKeeper may be a distributed and open source distributed application coordination service, and may be an open source implementation of Google's Chubby. ZooKeeper may be an important component of Hadoop and Hbase. ZooKeeper may be a software capable of providing consistent service to distributed applications, and the service may include: configuration management, naming service, distribution synchronization, group service, etc.

The sub-task allocating module 15 may be configured to split the task data into sub-tasks based on regions and operators, send the sub-tasks to corresponding target Work server, and maintain the connection relationship between the Work server and the sub-tasks.

Specifically, the sub-task allocating module 15 may split the task data by picking one out of two based on regions and operators, apply j son as the language for data exchange to program the task data, and apply asynchronous communication mechanism to send the task data.

Because the connection relationship between the sub-tasks and the Work servers are stored, when a Work server fails, the task may be recovered based on the connection relationship between the sub-tasks and the Work servers.

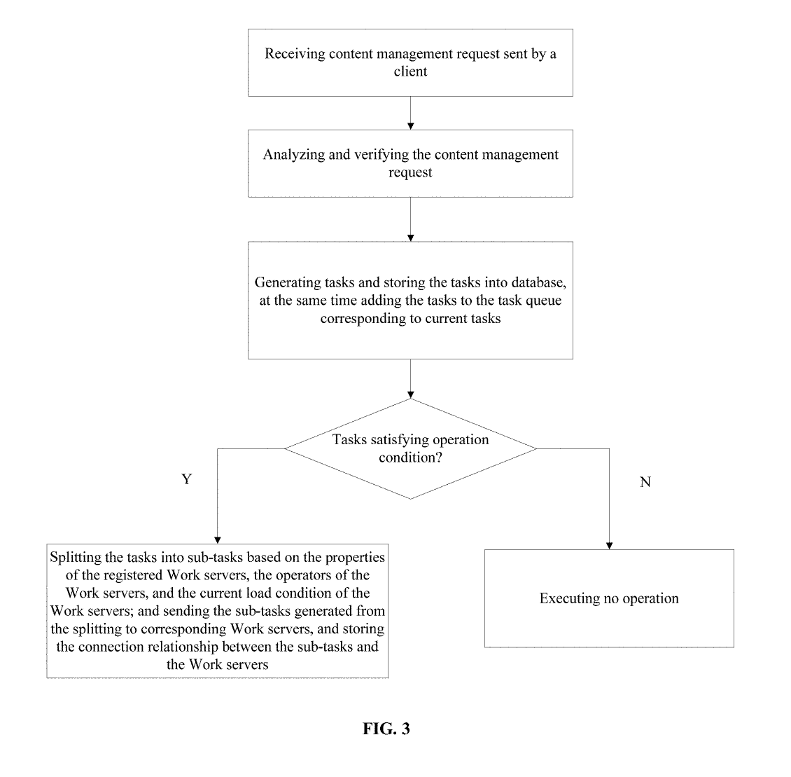

As shown in FIG. 3, the process flow of a Master server may include the following steps:

31) The Master server may receive the content management request submitted by a client, where the content management request may include but are not limited to push, prefetch, file verification (coverage) request, etc.;

32) The Master server may analyze and verify the content management request;

33) The Master server may generate a task and store the task into a data base, and at the same time add the task into the task queue corresponding to current tasks;

34) The Master server may obtain the tasks in each task queue, and determine if the tasks satisfy operation conditions based on clients' policies and configurations;

35) If the tasks satisfy operation conditions, the Master server may split the tasks into sub-tasks based on the properties of the registered Work servers, the operators of the Work servers, and the current load condition of the Work servers; and send the sub-tasks generated from the splitting to corresponding Work servers, and store the connection relationship between the sub-tasks and the Work servers; and

36) If the tasks fail to satisfy operation conditions, no operation may be executed.

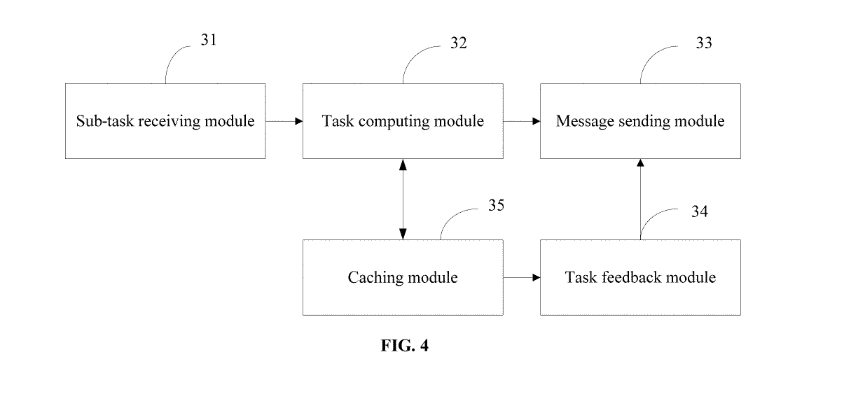

As shown in FIG. 4, a Work server may include a sub-task receiving module 31, a task computing module 32, a message sending module 33, a task feedback module 34, and a caching module 35. The task computing module 32 may be connected with the sub-task receiving module 31, the message sending module 33, and the caching module 35, respectively. The message sending module 33 may further be connected to the task feedback module 34.

The sub-task receiving module 31 may be configured to receive the sub-tasks sent by the Master servers, and add the sub-tasks into the task queue.

The task computing module 32 may be configured to calculate the ranges of the content caching servers covered by the tasks based on the clients' CDN acceleration information cached in the caching module, and generate task commands.

The message sending module 33 may be configured to send the task commands to all target computers.

Specifically, the message sending module 33 may apply highly-efficient JAVA NIO asynchronous communication mechanism, multiple channels, and proprietary protocols to send the task commands to all the target computers.

The task feedback module 34 may be configured to receive the task results from the content management client terminals, and update task progress based on task results. Specifically, the task feedback module may utilize JAVA NIO asynchronous communication mechanism to receive the task results from the content management client terminals, and update task progress based on task results.

The caching module 35 may be configured to cache the status of each node in the CDN network, and update the software and/or hardware failures of all nodes in real-time; and store and update the clients' service configuration data in real-time, and cache the calculation results of target tasks.

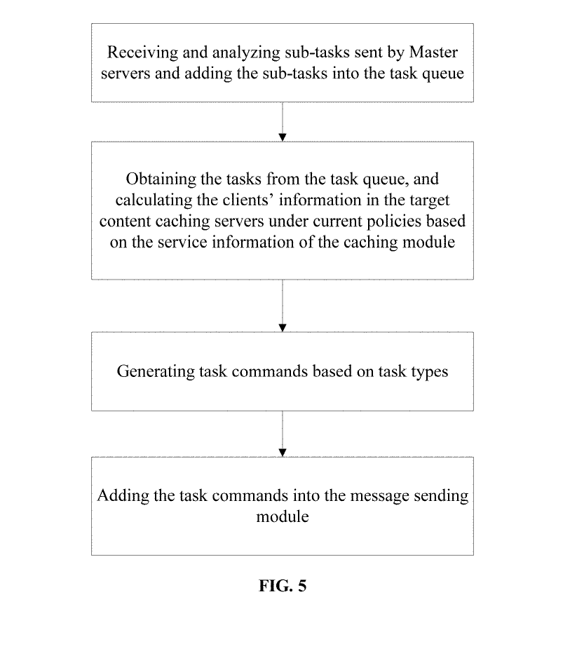

The main function of the Work servers may include receiving the tasks allocated by the distributed scheduling center, calculate the target tasks, configure task commands and send task commands to target computers, collect task results, and send the task results to the distributed scheduling center as feedback. As shown in FIG. 5, the process flow of a Work server may include the following steps:

51) The Work server may receive and analyze the sub-tasks sent by the Master servers, and add the sub-tasks into the task queue;

52) The Work server may obtain the tasks from the task queue, and calculate the clients' information in the target content caching servers under current policies based on the service information of the caching module;

53) The Work server may generate task commands based on task types; and

54) The Work server may add the task commands into the message sending module.

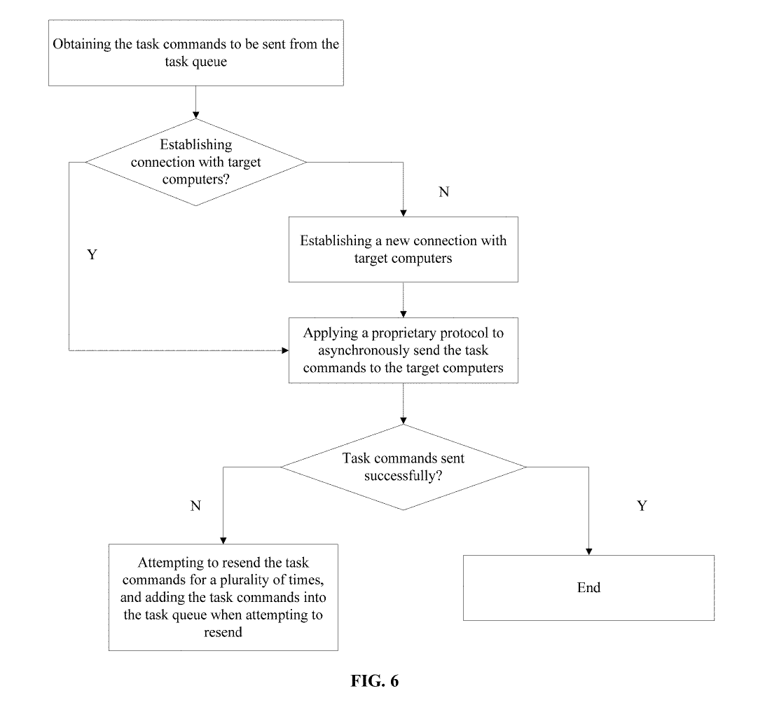

The message sending module may establish connections with target computers based on a one-to-many relationship, and send task commands with accuracy and high efficiency. As shown in FIG. 6, the process flow of the message sending module may include the following steps:

61) The message sending module may obtain the task commands to be sent from the task queue;

62) The message sending module may determine if connections may be established with target computers; if connections are established, the process may be directed to step 64); if no connections are established, the process may be directed to step 63);

63) A new connection may be established with target computers;

64) A proprietary protocol may be applied to asynchronously send the task commands to the target computers; and

65) The message sending module may determine if the task commands are successfully sent; if successfully sent, the process may end; if unsuccessfully sent, caused by a feedback from client terminal showing failure or a failure caused by a timeout, the message sending module may attempt to resend the task commands for a plurality of times, and may add the task commands into the task queue when attempting to resend.

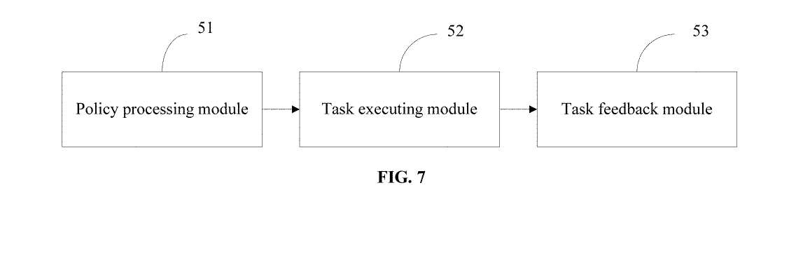

As shown in FIG. 7, the content management client terminal Beacon, deployed on a content caching server, may include a policy processing module 51, a task executing module 52, and a task feedback module 53, connected sequentially.

The protocol processing module 51 may be configured to receive and analyze the task commands sent by the Work servers, and add the task commands into the task queue.

The task executing module 52 may be configured to obtain the tasks from the task queue, and execute the tasks.

The task feedback module 53 may be configured to send task results as feedbacks to the Work servers.

Specifically, a process flow of the task executing module 52 may be as follows:

1) The task executing module 52 may determine the task types;

2) If the task is a prefetch task, the task executing module 52 may start downloading files, and report the download progress to Work servers on a regular basis;

3) If the task is a push task, the task executing module 52 may label the files as expired;

4) If the task is a file verification task, the task executing module 52 may calculate the MD5 values of the corresponding files; and

5) If the task is a file conversion task, the task executing module 52 may perform file conversion based on the target files.

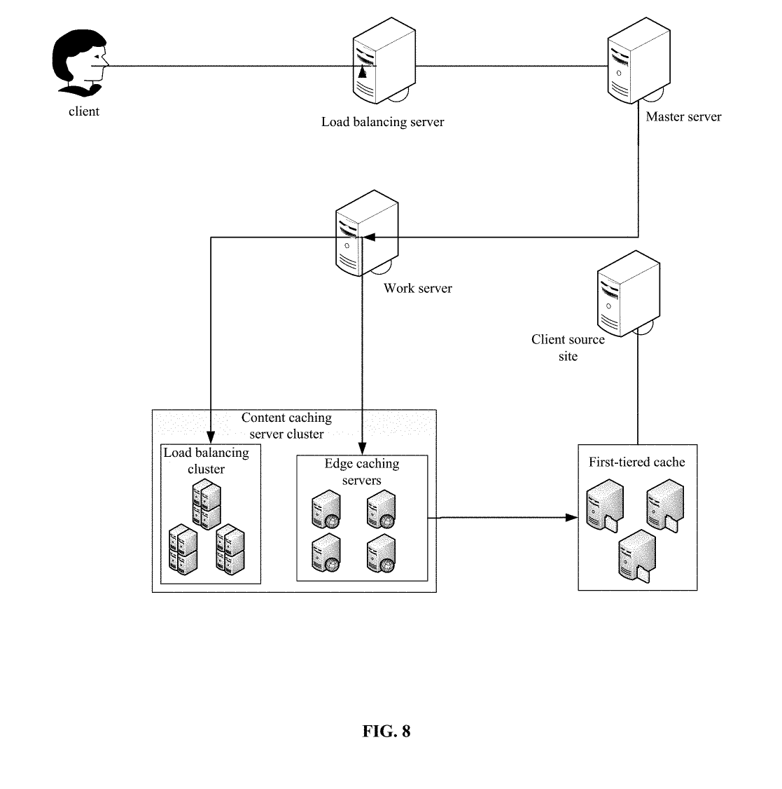

In the CDN network, to improve the users' experience when first accessing the network, the file content may be cached on the content caching servers before access by client terminals. This operation is referred to as prefetch. As shown in FIG. 8, for a prefetch task, an exemplary execution process may be as follows:

81) A client may submit a prefetch task request through API or webpages, e.g., http://www.a.com/test.flv;

82) The client's task request may be directed to any of the Master servers through load balancing servers such as lvs;

83) The Master server may verify task data, and direct the tasks to a currently prioritized Work server based on corresponding prefetch policies, and Work load property information registered on the ZooKeeper;

84) The Work server may calculate the acceleration ranges of the client in the CDN network, locate the load balancing server deployed with the accelerating node caching servers, and inquire the content caching server corresponding to the hashed prefetch url: http://www.a.com/test.flv.

85) The load balancing server may return the ip of the corresponding content caching server 2.2.2.2;

86) The Work server may, based on calculation and the inquired ip address of the content caching server, utilize high-performance synchronous communication mechanism and proprietary protocols to send a prefetch command to the content management client terminal of the content caching server; the content caching server may determine if the file http://www.a.com/test.flv already exists; if the file http://www.a.com/test.flv does not exist, the content caching server may request for the file from the first-tiered content caching server 1.1.1.1.

87) The first-tiered caching server may determine if the file http://www.a.com/test.flv exists, if the file does not exist, the first-tiered caching server may request for the file from the client source server, i.e., download the testily file directly from the client's domain www.a.com.

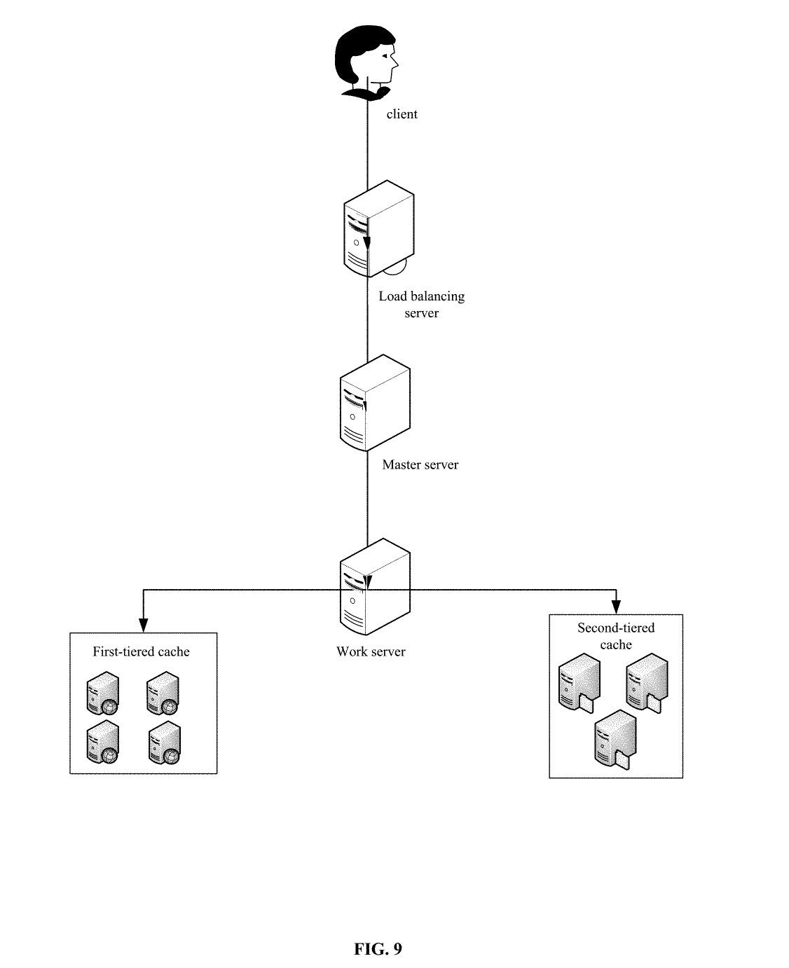

In the CDN network, after the client's file has been modified, an expiration process or deletion may be performed on the file cached in the CDN network. This operation is referred to as push. As shown in FIG. 9, an exemplary process flow of a push task may be as follows:

91) A client may submit a push task request, through API or webpages, e.g., http://www.a.com/test.flv;

92) The client's request may be directed to any of the Master server through the load balancing server such as lvs;

93) The Master server may verify task data, split the task into a plurality of sub-tasks based on corresponding push policies and information such as load on the Work servers, properties, and operators, registered in ZooKeeper, and allocate the sub-tasks onto a plurality of Work servers;

94) The Work servers may calculate the acceleration range of the client in the CDN network;

95) The Work servers may utilize high-performance synchronous communication mechanism and proprietary protocols to send push commands to the content management client terminal of the first-tiered content caching server, and the content management client terminal may push cached files; and

96) When completing all the push tasks on the first-tiered content caching server, push commands may be sent to second-tiered content caching servers to push files.

It should be noted that, the abovementioned embodiments are only illustrated using a two-tiered caching architecture. For a multi-tiered caching architecture, push tasks may be sequentially sent to multi-tiered caching servers.

Accordingly, the disclosed CDN-based content management system provides an entire set of content caching server for content management system. The content management system may manage the entire life cycle of the cached files in the content caching servers based on different media types; based on the acceleration ranges of source sites and the hotness level of the files, provide precise ranges, precise traffic control, and hotspot prefetch functions, to improve user's experience of the first access to the websites; utilize high-performance asynchronous communication mechanism, compressed proprietary protocols, and multi-channel architecture to allocate tasks such that the throughput and the timeliness of the massive content management tasks may be satisfied; by providing verification of the coverage of the content cached files, verify the file coverage at content caching nodes at any time under current service; provide different types of management operations for different media such as images, videos, live broadcast, webpages, etc.; and by lateral extension distribution of the Work servers, increase the throughput of the system without modifying code or ending service. Thus, the present disclosure effective overcome various shortcomings in the conventional technology, and therefore has high industrial utilization value.

The above embodiments are only exemplary to illustrate the principles and effects of the present disclosure, and are not intended to limit the scope of the present disclosure. Any person skilled in the art can make modifications or changes to the abovementioned embodiments without departing from the spirit and scope of the present disclosure. Thus, all equivalent modifications or changes by those skilled in the art, without departing from the spirit and technology disclosed by the present disclosure should also be covered by the claims of the present disclosure.

What is claimed is:

1. A CDN-based content management system, comprising: a distributed scheduling center, a big data center, a task executing server cluster, a distributed reliability coordinating system, and content caching servers, wherein:
the distributed scheduling center includes a plurality of distributed scheduling servers, and is configured to schedule tasks based on client requests;
the big data center is configured to store client task request data, and count and analyze task data;
the task executing server cluster is deployed in different regions and different operators, configured to receive task conversion commands sent by the distributed scheduling servers, and send task commands to content caching servers of corresponding regions and operators;
the distributed reliability coordinating system is configured to store status and properties of all servers in the content management system; and
the content caching servers are configured to cache client files, and the content caching servers are arranged with a content management client terminal; and the content management client terminal executes tasks allocated by a task executing server and send task results as feedback to the task executing server.

2. The CDN-based content management system according to claim 1, wherein: in the distributed scheduling center, one distributed scheduling server is selected as a central scheduling server, when any one of the distributed scheduling servers fails, the central scheduling server selects another distributed scheduling server to take over work load of failed distributed scheduling server, and when the central scheduling server fails, other distributed scheduling servers select a new central scheduling server to take over work load from previous central scheduling server.

3. The CDN-based content management system according to claim 1, wherein a distributed scheduling server comprises a system interface module, a task scheduling module, a policy module, a task executing load balancing module, and a sub-task allocating module;
the system interface module is configured to receive and verify client content management requests, store task data, and simultaneously add tasks into a task queue;
the policy module is configured to generate different policies for clients based on service configuration data and client types;
the task scheduling module is configured to obtain tasks from the task queue based on the policy and configuration of current clients, initiate the tasks and schedule tasks for execution;
the task executing load balancing module is configured to register current load, CPU, memory, and task allocation of the task executing servers, and based on principles of prioritizing same region and operators, select a task executing server having a lowest synthetic load to execute allocated tasks; and
the sub-task allocating module is configured to split the task data into sub-tasks based on regions and operators, send the sub-tasks to corresponding target task executing server, and maintain a connection relationship between the task executing server and the sub-tasks.

4. The CDN-based content management system according to claim 3, wherein the sub-task allocating module splits the task data by picking one out of two based on regions and operators, uses j son as a language for data exchange to program the task data, and uses asynchronous communication mechanism to send the task data.

5. The CDN-based content management system according to claim 1, wherein: the task executing server includes a sub-task receiving module, a task computing module, a message sending module, a task feedback module, and a caching module;
the sub-task receiving module is configured to receive sub-tasks sent by the distributed scheduling servers, and add the sub-tasks into a task queue;
the task computing module is configured to calculate ranges of the content caching servers covered by the tasks based on client CDN acceleration information cached in the caching module, and generate task commands;
the message sending module is configured to send the task commands to all target computers;
the task feedback module is configured to receive task results fed back from the content management client terminals, and update task progress based on the task results; and
the caching module is configured to cache a status of each node in the CDN, and update software and hardware failures of all nodes in real-time; and store and update the client service configuration data in real-time, and cache calculation results of target tasks.

6. The CDN-based content management system according to claim 5, wherein: when the message sending module is sending the task commands to the target computers, if the task commands are unsuccessfully sent, caused by a feedback from client terminal showing failure or a failure caused by a timeout, the message sending module attempts to resend the task commands for a plurality of times, and adds the task commands into the task queue when attempting to resend.

7. The CDN-based content management system according to claim 1, wherein the content management client terminal includes a policy processing module, a task executing module, and a task feedback module;
the protocol processing module is configured to receive and analyze task commands sent by the task executing servers, and add the task commands into a task queue;
the task executing module is configured to obtain tasks from the task queue, and execute the tasks; and
the task feedback module is configured to send task results as feedback to the task executing servers.

8. The CDN-based content management system according to claim 7, wherein: when executing a task, the task executing module first determines task types; if the task is a prefetch task, the task executing module starts downloading files, and reports a download progress to the task executing servers on a regular basis; if the task is a push task, the task executing module labels files as expired or deletes the files; if the task is a file verification task, the task executing module calculates MD5 values of corresponding files; and if the task is a file conversion task, the task executing module performs a format conversion based on target files.

9. The CDN-based content management system according to claim 8, wherein: an execution of a prefetch task includes following steps:
a client submitting a prefetch task request;
a client task request being directed to any of the distributed scheduling servers through a load balancing server;
the distributed scheduling server verifying task data, and directing tasks to a currently prioritized task executing server based on corresponding prefetch policies, and load property information of the task executing server;
the task executing server calculating acceleration ranges of the client in the CDN, locating the load balancing server deployed with an accelerating node caching server, and inquiring a corresponding content caching server;
the load balancing server returns an ip of the corresponding content caching server; and
the task executing server sending a prefetch command to the content management client terminal of the content caching server; determining if a file for the prefetch exists; if the file does not exist, the task executing server requesting for the file from a first-tiered content caching server; and the first-tiered content caching server determining an existence of the file; if the file does not exist, the first-tiered content caching server requesting for the file from a client source server.

10. The CDN-based content management system according to claim 8, wherein an execution process of the push task includes following steps:
a client submitting a push task request;
the client request being directed to any of the distributed scheduling servers through a load balancing server;
the distributed server verifying task data, splitting task into a plurality of sub-tasks based on information of regions or operators, and allocating the sub-tasks onto a plurality of task executing servers;
the task executing servers calculating acceleration ranges of the client in the CDN based on information of regions or operators;
the task executing servers sending push commands to the content management client terminal of a first-tiered content caching server, and the content management client terminal pushing cached files; and
when completing all the push tasks on the first-tiered content caching server, sending push commands to a second-tiered content caching server to push files.
